(19) United States
(12) Patent Application Publication
(10) Pub. No.: US 2003/0221130 A1
(43) Pub. Date: Nov. 27, 2003

(54) Digital distribution of validation indicia

(76) Inventor: Steven G. Henry, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/154,616

(22) Filed: May 22, 2002

(51) Int. Cl. H04L 9/32

(52) U.S. Cl. 713/202; 382/115

(57) ABSTRACT

A digital image is composed at a digital transmitter device. The digital image includes an optically scanned image received at a scanning mechanism of the digital transmitter device and a handwriting image received at a touch sensitive input device of the digital transmitter device. A validation routine is performed using the handwriting image against an access control database. If valid, a network message is transmitted, including the digital image, from the digital transmitter device to an electronic address that includes an address of a network resource and a destination location thereat.

### FIELD OF THE INVENTION

The present invention relates generally to peripheral devices, and more particularly to digitally collecting and distributing a validation indicia.

### BACKGROUND OF THE INVENTION

Many peripherals to computer networks include a scanner component. One example of such a peripheral is an “All-in-one”, also known as a multifunction peripheral (MFP) in that it has the capability to perform the multiple functions of scanning hardcopy documents, copying, and printing. Another example is a digital network copier that scans in documents from an automatic document feeder, does high volume copying, and has the capabilities of binding, collating, folding, stacking, stapling, stitching, edge-trimming, paginating, and printing on substrates of varied composition. Each of these peripherals, when in communication with an interconnecting network, can also be described as being a digital transmitter device. A digital transmitter device is an appliance that has an input device (e.g. a keyboard), a display, and a scanner. The digital transmitter device need not have a printer. A digital camera is a type of digital transmitter device, but in comparison to the foregoing, it is not as useful for handling documents and typically lacks the resolution and ability to rapidly and repetitively transfer information after scanning to a repository.

In an exemplary digital transmitting operation, a hardcopy of a document or other physical object can be presented to the scanner portion of a digital transmitter device. After scanning, the digital transmitter device transforms the scanned image into a digital representation that is then saved in a data format, such as in a bit map data format or in a Portable Document Format (PDF). Electronic messaging can be used to send an electronic mail (e-mail) message from the digital transmitter device with an attachment of the digitized representation in the data format. The e-mail message can be sent to recipients over an interconnecting network, where the recipients have an e-mail address that a user manually enters at the digital transmitter device or that a user specifies using a predefined defined list of recipient e-mail addresses that can be stored in a memory of the digital transmitter device.

While digital transmitter devices provide significant advantages, e-mail recipients and senders may have reservations. The recipient of an e-mail message may not be sure as to the real identity of the user who sent the e-mail message. It would be beneficial to provide e-mail recipients with additional information to ascertain the identity of sender of the e-mail message. The sender of an e-mail message may be concerned as to the protection of the copyright in the documents being sent, such as when a professional photographer transmitted digital photographs in an e-mail message. It would be beneficial to provide e-mail senders with a safeguard in mitigation of against copyright infringement. Consequently, there is a need for improved methods, systems, and programs that can provide such a capability.

### SUMMARY OF THE INVENTION

The above-stated needs and/or others are met, for example, by methods, systems, and programs for composing a digital image at a digital transmitter device. The digital image includes an optically scanned image received at a scanning mechanism of the digital transmitter device and a handwriting image received at a touch sensitive input device of the digital transmitter device. A validation routine is performed using the handwriting image against an access control database. If valid, a network message is transmitted, including the digital image, from the digital transmitter device to an electronic address including an address of a network resource and a destination location thereat.

### DESCRIPTION OF THE DRAWINGS

A more complete understanding of the various methods, systems, and programs of the present invention may be had by reference to the following detailed description when taken in conjunction with the accompanying drawings wherein the same reference numbers are used throughout the drawings to reference like components and features, and wherein:

FIG. 1 is a block diagram, according to an embodiment of the present invention, depicting a computing and communication environment having various digital transmitter devices in a system environment suitable for providing local access to the digital transmitter devices.

FIG. 2 is a block diagram, according to an embodiment of the present invention, illustrating a digital transmitter device in communication through a wired or wireless link to an interconnecting network to which a server is also in communication.

FIGS. 3-5 illustrate examples of menu pages that might be displayed on a touch sensitive menu screen of a digital transmitter device and transition sequences among the menu pages, according to an embodiment of the present invention.

FIG. 6 illustrates an example, according to an embodiment of the present invention, of a paper document to be optically scanned into a scanning mechanism of a digital transmitter device.

FIG. 7 is the paper document of FIG. 6 after it has been composed by the digital transmitter device with a manually input signature and User ID superimposed thereon.

FIG. 8 a flow diagram, according to an embodiment of the present invention, depicting a method for use in a computing and communication environment having a digital transmitter device in a system as in FIG. 1, for example, in accordance with certain exemplary embodiments of the present invention.

### DETAILED DESCRIPTION

The methods, systems, and programs described herein, according to various embodiments of the present invention, relate to the transmission of message data via electronic mail (e-mail) message from a digital transmitter device to one or more e-mail address(es). When an e-mail message is sent from a digital transmitter device, message data attached to the e-mail message can include an image that has been composed as digitized images of documents that were captured by the digital transmitter device using a scanning mechanism. The digitizing of the composition process for the message data can also include handwriting, or other indicia, that was captured using an input device, such as a touch sensitive menu screen. Preferably, the result of the composition or digitizing process will be that the handwriting, or other indicia, will be superimposed on the image that has been composed or digitized. As such, the resultant appearance of the rendered documents sent in the e-mail message will be that the handwriting, or other indicia, will appear to be integral or a part of the original images on the documents that were captured by the scanning mechanism.

When a user scans in a set of documents to a digital transmitter device to be sent in an e-mail message, the user also keys in their user ID and uses a pen or stylus upon a touch sensitive menu screen to mark a signature or other indicia of identity (e.g. initials of the signer). The digital transmitter device, or other network device, then performs known validation or access processes to validate one, all, or none of the User ID and the manually input signature. In order to determine whether or not a user has sufficient access to send the scanned documents by e-mail message to an e-mail address specified by the user, an inquiry can be made to a location at which user identification codes are stored, such as at a network device (e.g. a server) in communication with the digital transmitter device, or at the digital transmitter device itself. The inquiry can use the User ID as the code for accessing the storage location to obtain a digital representation of a handwritten signature for comparison to the manually input signature that was captured by the digital transmitter device on the touch sensitive menu screen. Other known identification criteria can also be used to ascertain signature validity, such as the speed at which the signature is executed.

The storage location will preferably contain User ID access control information for each User ID on a particular network or for a particular digital transmitter device. Alternatively, the User ID access control information can contain the user ID and a respective representation of a signature for a plurality of digital transmitter devices that are in communication with a common interconnected network.

The result of the inquiry is the return of the status of the validation check. The digital transmitter device reviews the status of the validation check specified by the user for the scanned document e-mail job. If there is an invalid status, then the digital transmitter device will display a diagnostic indicating so. The user then may input to the digital transmitter device a different User ID and/or signature. This procedure can continue until the User ID and signature are eventually validated. Upon acceptance, the scanning mechanism initiates the scanning process to optically capture the images on one or more documents. The optically captured images, including the manually input signature, are subject to a document composition routine at the digital transmitter device. The document composition routine puts the optically captured images into a data format that reflects the presence of, and the integration with, a superimposed rendering of the User ID and manually entered signature upon each page that is rendered in the data format.

As an alternative, the validation process or other access control check can be skipped. In this case, the process would proceed as described above superimposing the User ID and/or the manually entered signature on each page that is rendered in the data format by the document composition routine. In this case, the recipient of the e-mail message could review the superimposed images of the User ID and/or the handwritten signature, and, if desired, apply a validation process. As a further alternative, when the validation process or other access control check results in a negative validation of the User ID and/or the handwritten signature, the e-mail message can still be sent and the rendered document attached to the e-mail message may include a notation that the result of the validation was negative.

The location of the access control information and related signature representation for each User ID on a network can be quite diverse. For example, a digital transmitter device can function independently so that each user's User ID and associated signature representation is maintained by the digital transmitter device. As such, the digital transmitter device would perform the validation for each manually entered User ID and/or signature to validity and/or access to use of the digital transmitter device prior to the sending of an e-mail message to an e-mail address that was specified by the user. In this case, a query need not be made to another network device, such as a server, with which the digital transmitter device is in communication through an interconnected network.

### Exemplary System for Configuration of a Digital Transmitter Device

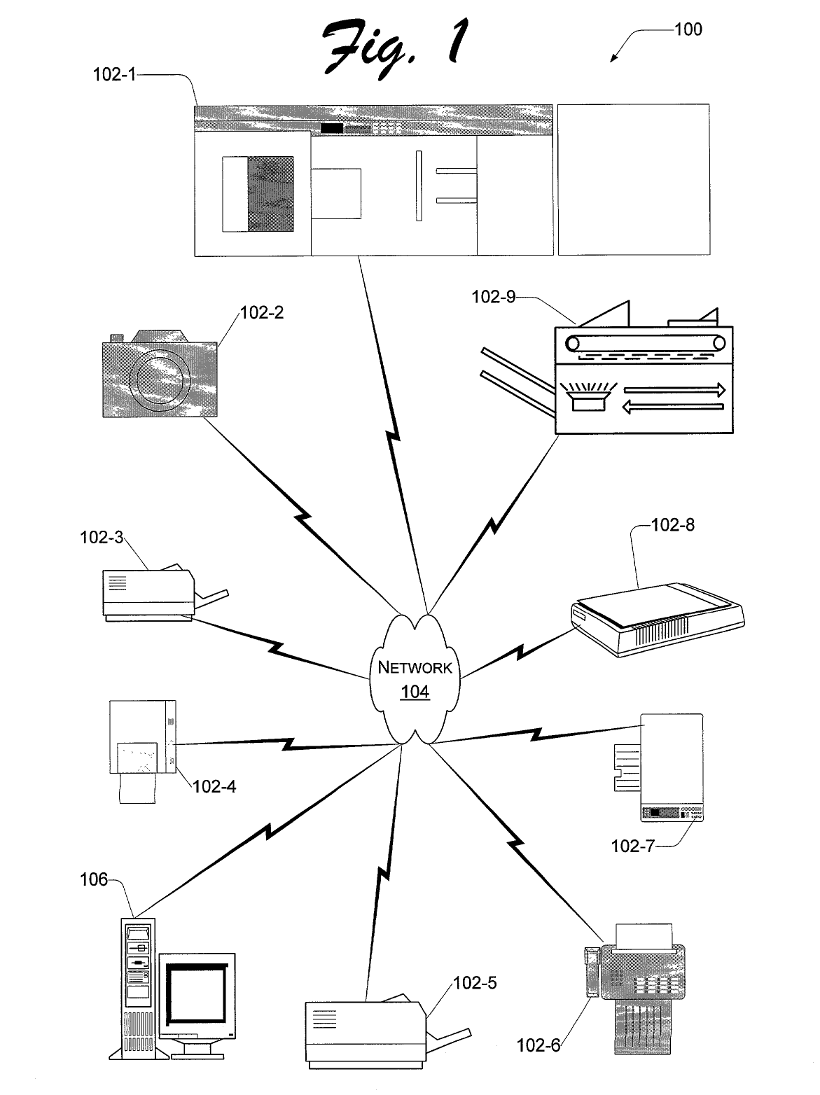

FIG. 1 illustrates an example of a system environment 100 suitable for implementing an embodiment of the present invention. The system environment 100 contemplates a plurality of digital transmitter devices 102-i that can be in communication with an interconnected network 104. Interconnected network 104 is in communication with one or more server(s) 106. Each server 106 can be an e-mail message server that serves one or more e-mail addresses to which any digital transmitter device 102-i can send an e-mail message. Digital transmitter devices 102-i generally include peripheral devices and stand-alone devices. Peripheral devices include devices such as printers, scanners, copiers, and fax machines, or multifunction peripheral (MFP) devices that combine two or more peripheral devices into a single device. Stand-alone devices include certain peripheral devices that often function while uncoupled or isolated from other devices. Digital transmitter devices 102-i therefore include devices such as copiers, scanners and fax machines such as those shown in FIG. 1.

Digital transmitter devices 102-i are generally distinguishable from devices such as laptop PCs (personal computers) and pocket PCs by their limited purpose and limited user interface or input/output capabilities. For example, a typical user interface for a digital transmitter device 102 includes a front menu panel with limited screen space and a limited number of buttons. In addition, a digital transmitter device 102-i is typically oriented toward performing one general task such as scanning. By contrast, devices such as laptop and pocket PCs often provide multiple and varied means of input/output such as a full screen display, a QWERTY keyboard, a trackball mouse, speakers, microphones, PCMCIA (Personal Computer Memory Card International Association) slots, portable media drives and the like. These devices are capable of performing multiple functions through executing various software applications such as word processing applications, spreadsheet applications, financial applications, network browsers and network messaging applications.

Digital transmitter device 102-2, seen in FIG. 1, is intended to represent both a digital camera and a type of portable hand held scanner to capture and digitize images. The camera and the portable hand held scanner capture images is a fashion that can be mobile relative to the object from which the image is to be captured. Each of the camera and the portable hand held scanner can have a document composer component to digitize images captured thereby. In the case where digital transmitter device 102-2 is a digital cameral, a photographer can use an input device associated with the digital camera to make a handwritten symbol, such as the photographers signature, a trademark, or a handwritten condition for use of the photographs. The handwriting will then be superimposed over the photographs in the e-mail message that is sent so as to appear to be integral therewith. In this way, the recipient of the e-mail message will not be able to freely make copies of the photographs without the superimpositions that were intended to be present by the e-mail sender.

Also shown are various multifunction peripherals (MFPs) 102-3 through 102-5, 102-7, and 102-9. FIG. 1 also depicts a facsimile machine 102-6, a desk top scanner 102-8, and a high volume copier 102-1 that includes the capabilities of printing on substrates of varied composition, binding, collating, folding, stacking, stapling, stitching, edge-trimming, and paginating.

Interconnecting network 104 is representative of one or more communication links, either wired or wireless, that are capable of carrying data between server 106 and other network resources in communication with interconnecting network 104. In certain exemplary implementations, interconnecting network 104 includes a local area network (LAN), a wide area network (WAN), an intranet, the Internet, or other similar network.

Local access to each digital transmitter device can be provided through an input device, such as a touch sensitive menu screen, on each digital transmitter device 102-i. A user accesses the input device via a user interface for the purpose of entering commands, a User ID, one or more e-mail addresses, and optional message text for an e-mail message that the user wishes to send. Alternatively, a default e-mail address or a list of selectable e-mail addresses can also be stored at each digital transmitter device 102-i. Preferably, each digital transmitter device 102-i will have an imaging or scanning mechanism to receive images of an object. A document composer component in each digital transmitter device 102-i then composes a document by digitizing a manually input signature and/or User ID superimposed over the images of the scanned object, as discussed below. The composed documents can then be sent in a file attached to an e-mail message that is addressed to the input, default, or selected e-mail address(es) from digital transmitter device 102-i through interconnected network 104 to one or more e-mail servers 106 for the respective e-mail address(es) input or specified by the user.

The user of digital transmitter device 102-i seen in FIG. 1 can transmit message data to interconnected network 104 by a wired or wireless link. A wireless link can be through an Infrared (IR) data connection or other wireless data connections such as the Blue Tooth protocol. The wireless link may be made through radio frequency (RF) or infra-red (IR) data ports. By way of example, digital transmitter device 102-i can include the capabilities of a cordless handset telephone, a cellular telephone, a personal digital assistant (PDA), a pager, a watch and the like, any of which is also capable of transmitting data in a wireless manner. A wired link can be performed through a USB data connection, a serial port connection, a parallel port connection or via other known data transmission standards and modes. The wired link may be implemented through standard RS232 cable, Universal Serial Bus (USB) cable, or IEEE 1394 (i.link/Lynx/Fire Wire™) connection data ports. As such, digital transmitter device 102-i can transmit by one or both of a wireless or wired link.

### Exemplary System for a Digital Transmitting Device in Communication with a Server

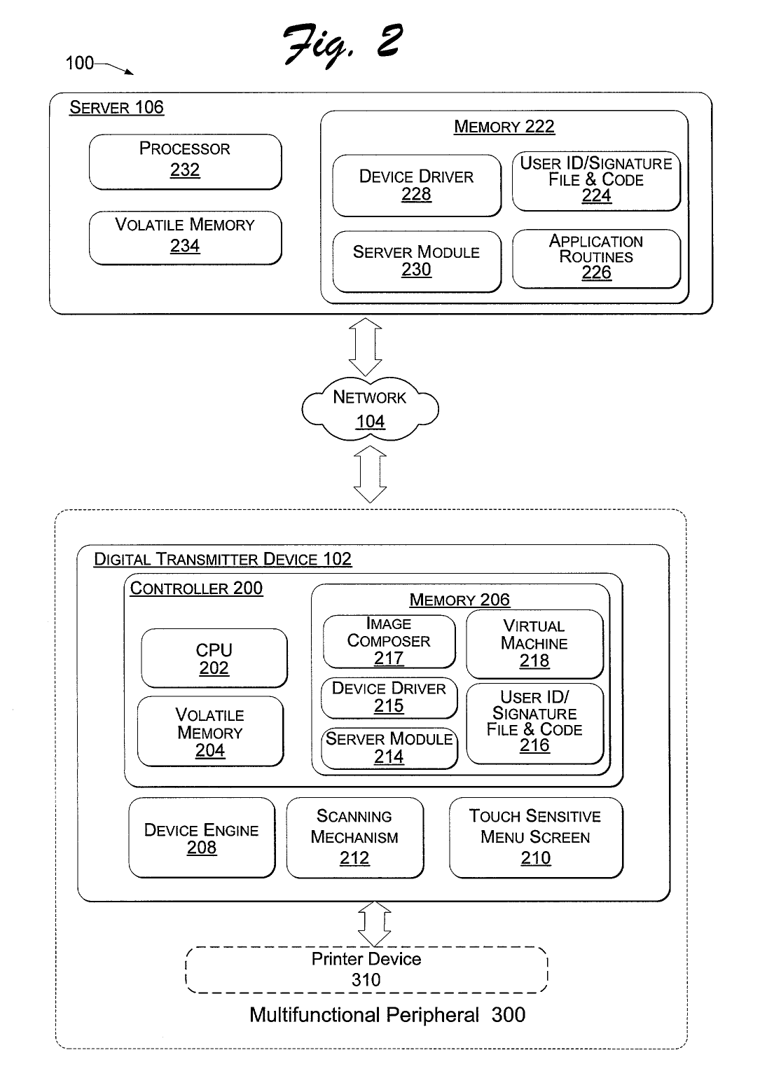

The system 100 of FIG. 2 includes digital transmitter device 102 as a peripheral device coupled by a wired or wireless link to interconnecting network 104 and to server 106 through interconnected network 104. As such, FIG. 2 illustrates an embodiment of the system 100 of FIG. 1 in greater detail. In accordance with still other aspects of the present invention, digital transmitter device 102 may be included within a multiple function peripheral (MFP) device 300. As its name implies, the MFP device 300 is configured to provide multiple functions. In this example, the functions provided by the MFP device 300 include those provided by digital transmitter device 102 and a printer device 310. Consequently, the user of digital transmitter device 102 may also print out a hardcopy of any applicable portions of data stored or otherwise acquired by digital transmitter device 102.

In general, digital transmitter device 102 uses a controller 200 to execute a program that can be stored in an image composer 217 of a memory 206 to compose documents from images that are captured by scanning documents or other objects using a scanning mechanism 212. The program in image composer 217 can also be used to render superimposed handwriting received at an input device of digital transmitter device 102 over the composed documents. Alternatively, the document composition program can be stored, in full or in part, in scanning mechanism 212. Controller 200 also executes a program so as to transform data to a driver format suitable for printing with integral printer device 310, such as a mark up language format (e.g. SMGL, HTML, or XML), or such as a job language format (e.g. PCL or postscript). Printer device 310 can have the capability of converting data and then outputting it onto an appropriate print media, such as paper, transparencies or glossy photo paper.

Digital transmitter 102 includes one or more CPUs 202, each of which is operatively coupled to memory 206, and a user interface that includes an input device. Preferably, the input device will be locally accessible at digital transmitter device 102. By way of example, the input device can be a touch sensitive menu screen 210. Digital transmitter device 102 also includes at least one communication port for interfacing with interconnecting network 104 through either a wired or wireless link.

When included in MFP device 300, CPU(s) 202 would also be operatively coupled to printer device 310, for example. CPU(s) 202 is representative of any hardware, firmware and/or software that is configured to perform certain functions associated with the operation of digital transmitter device 102. Hence, as those skilled in the art will recognize, CPU(s) 202 may include dedicated logic and/or one or more processors configured in accord with software instructions, for example.

Memory 206 is representative of any type of data storage mechanism that can be accessed by at least CPU(s) 202. Memory 206 may therefore include, for example, some form of random access memory (RAM), some form of read only memory (ROM), and/or other like solid-state data storage mechanism. Memory 206 may include a magnetic and/or optical data storage mechanism. Scanning mechanism 212 is representative of any optical scanner technology that may be employed to produce scanned object data upon scanning an object. Such scanning technologies are well known. The resulting scanned object data is provided to CPU 202 and/or stored in memory 206.

Controller 200 of digital transmitter device 102 typically includes data processing unit or CPU 202, a volatile memory 204 (i.e., RAM), and a non-volatile memory 206 (e.g., ROM, Flash). Digital transmitter device 102 also includes a device engine 208. The touch sensitive menu screen 210 acts as a local user interface for digital transmitter device 102 by displaying menu pages and accepting user input based on selectable menu items displayed on the menu pages. The touch sensitive menu screen 210 can be used to display a menu page that asks for and receives the input of an e-mail address to which to image data that is scanned with scanning mechanism 212 is to be transmitted in an e-mail message via interconnected network 104.

Controller 200 processes data and manages device functions by controlling device engine 308 and by responding to input from touch sensitive menu screen 210. Device driver software in a device server 312 can be stored in memory 206 and executed on CPU(s) 202. Memory 206 also includes a server module 214 configured to serve menu documents to the touch sensitive menu screen 210. The server module 214 is a local server in the sense that it is present within the same digital transmitter device 102 to which it serves menu documents.

Controller 200 can optionally include a User ID/Signature File and Code component 216 that is stored in memory 206 that storage software and data to validate a user identification code (User ID) and a corresponding digital representation of a signature. Alternatively, server 106 can perform this function through User ID/Signature File and Code component 224 that is stored in a memory 222 of server 106.

Menu documents stored in memory 206 can be interpreted by the server module 214 and are configured to display textual and graphical information as menu pages on the touch sensitive menu screen 210. The menu documents driving the menu pages can include script code that is associated with graphical keys. The term “script code” is intended herein to mean any one of a variety of different code types. Various kinds of code are contemplated. By way of example, the code can be implemented in embedded script code, in firmware, in a native code such as C++ code, or can be JAVA script. The code can be written in JavaScript code that is interpreted and executed on a Java Virtual Machine (JVM). The code can also be written in other script code languages such as VBScript or Perl.

Selecting a menu item by pressing a graphical key on the touch sensitive menu screen 210 triggers an event which causes a “virtual machine” 218 to interpret and execute the script code associated with the selected graphical key. The virtual machine 218 is a software module stored in memory 206 that executes on CPU(s) 202 to interpret and execute script code. The script code can be associated with selectable menu items (i.e., graphical keys or buttons). One menu item is configured to initiate a scan of an image using the scanning mechanism 212. Another menu item is configured to perform the task of receiving input that includes a User ID, a priority code, and an e-mail address(es) to which e-mail message data is to be sent via interconnected network 104. Still another menu item can be configured to perform the task of initiating a retrieval of an e-mail address that was previously stored in memory 206. Memory 206 can optionally contain e-mail address information that can be requested to be displayed upon touch sensitive menu screen 210. When the e-mail address information is retrieved from memory 206, the user can select a displayed e-mail address to which an e-mail message will be transmitted over interconnected network 104 to another digital transmitter device 102-i as seen in FIG. 1. Alternatively, the user can directly enter a specific e-mail address into the digital transmitter device 102 using touch sensitive menu screen 210. Controller 200 executes processes resident in a communicative link interface for a transmission (e.g. an e-mail message) that can be transmitted over a wired and/or wireless link to interconnected network 104.

Before or after a user has been validated as to the User ID and manually input signature, the user can enter a command displayed on touch sensitive menu screen 210 to initiate a scanning operation, The user places a set of documents into a sheet feeder device associated with digital transmitter device 102. The sheet feeder device then physically feeds each sheet in the set of documents to scanning mechanism 212. CPU 202 processes software or other machine executable code stored in image composer 217. The image composer 217 then generates a bit map or other output that is a digital representation of the scanned documents in a document composition process. The bit map or other digital representation of one or more documents is composed by image composer 217 to include superimposed thereon the manually input signature and/or User ID. While the rendering of the superimposed signature and/or User ID can be performed in a variety of ways, it is preferred that the rendering be somewhat light in the weight thereof, such as having the appearance of a water mark, so that the one or more superimpositions do not substantially obscure any portion of the images on the rendered documents. Nevertheless, it is preferable that the superimpositions appear to be integral with the images on the rendered document so that their appearance thereon is easily noticed and could be not easily removed. To further minimize not obscuring any portion of the images on the rendered documents, the superimposed signature can be situated in a margin or scaled so as to be small relative to the rendered document page size. To do so, the digital transmitter device can be configured, manually or otherwise, to have control over the location and size of the water mark on the rendered documents.

Once the document composition process has digitized the scanned object data with the superimpositions discussed above, the composed documents can be sent in an e-mail message as an attached file to an e-mail address(es) that was specified by the user.

It is preferred that image composer 217 of memory 206 provide the digital transmitter device 102 with the capability of performing a variety of document composition routines for a plurality of data formats, including an American Standard Code for Information Interchange (ASCII) formatted data format, a word processor format, a spread sheet data format, a Portable Document Format (PDF) data format, a slide show software data format such as the Power Point® software data format from Microsoft Corporation of Redmond Wash., USA, a graphic image file format (GIFF) data format, a tagged image file format (TIFF) data format, a Joint Photographic Experts Group (JPEG) data format, a bit-map data format, an optical character recognition (OCR) data format, and/or other forms of encoded data, including, e.g., encrypted data, etc.

When the user enters a command displayed upon touch sensitive menu screen 210 to enter or retrieve an e-mail address, digital transmitter device 102 coordinates the input of the e-mail address. Controller 200 then executes a user message compositing routine, preferably stored in memory 206, that assemblies message data. The message data so assembled includes the e-mail address input or otherwise designated by the user, the bit map or other output that is a digital representation of the scanned documents with the superimposed representation of the manually input signature and/or User ID, and can also include any message text entered by the user upon touch sensitive menu screen 210. The message data is then sent by a wired and/or wireless link from digital transmitter device 102 to interconnected network 104. From interconnected network 104, a communication is established with an e-mail server that is also in communication therewith. The e-mail server serves the e-mail address to which the e-mail message from digital transmitter device 102 is to be sent. By way of example server 106 can, but need not, function as the e-mail server of any e-mail address of digital transmitter devices 102-i seen in FIG. 1. Alternatively, a server in communication interconnected network 104, other than server 106, can be the e-mail server for e-mail addresses associated with digital transmitter devices 102-i.

CPU(s) 202 is configured to perform the operations described above using various executable modules of memory 206, such as an e-mail address storage/retrieval routine, a communicative link interface routine, and a user message compositing routine, any of which can each be implemented in software or firmware.

In one embodiment of the invention, an e-mail address storage/retrieval routine executing on CPU(s) 202 receives input of an e-mail address from a user at touch sensitive menu screen 210 or retrieves a list of stored e-mail addresses. The list of e-mail addresses are displayed on touch sensitive menu screen 210 in a hierarchical list. The list can be sorted alpha-numerically. The user can either select from among the displayed e-mail addresses or input the characters of a specific e-mail address using a ‘drill-down’ function of the menu, as discussed below with respect to FIGS. 3-5. The drill-down menu format and the displayed list of retrieved e-mail addresses assist the user in locating an e-mail address of interest.

FIG. 2 shows server 106 in communication with interconnected network 104 and having a processor 232, a volatile memory 234, and memory 222. Memory 222 includes a device driver 228, a server module 230, optionally the User ID/Signature File & Code component 224 discussed above, and application routines 226 for storage of software or other machine executable code. Application routines 226 are storage locations for programs that can be executed by processor 232 on server 106. One such routine is a routine to validate User IDs and associated manually input signatures that are input upon touch menu screen 210 of digital transmitter device 102 as was discussed above.

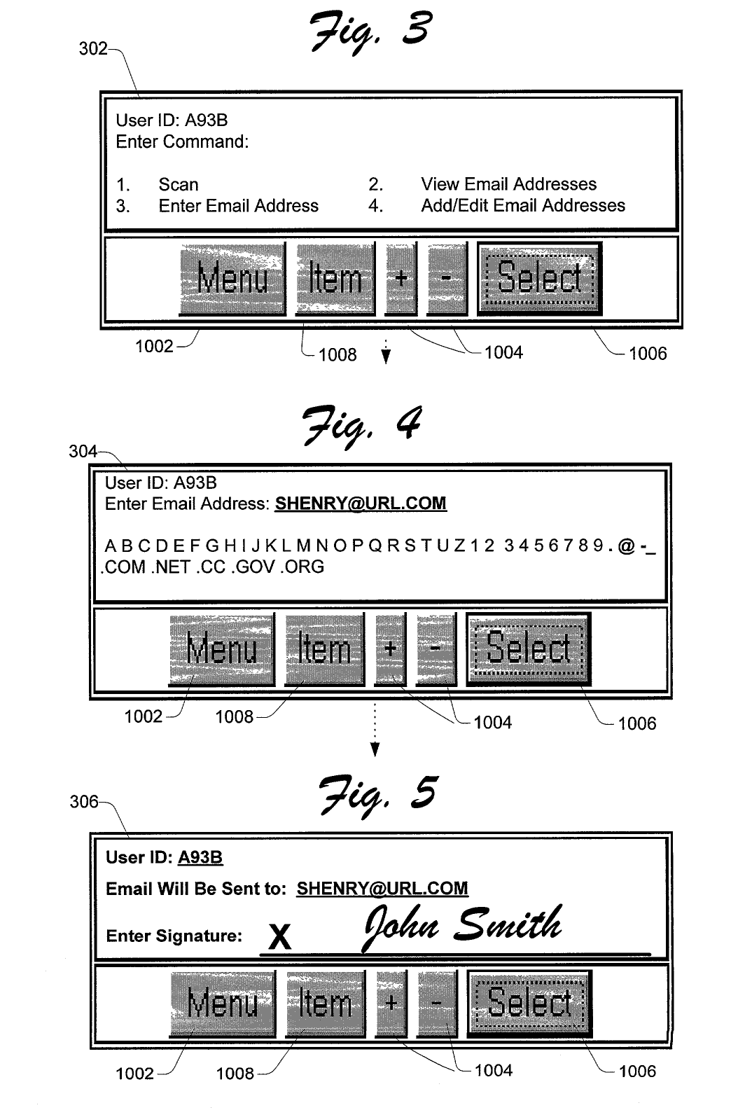

As mentioned above, a user interface device can be used to accept the input of a User ID, an e-mail address, and a manually input signature from a user at the digital transmitter device. By way of example, a sequence of menus that can be displayed upon touch sensitive menu screen 210 of digital transmitter device 102 is seen in FIGS. 3-5. The menus depicted in FIGS. 4-5 show a ‘drill-down’ function. A menu screen 302 is displayed upon touch sensitive menu screen 210 of digital transmitter device 102-i. Menu screen 302 shows various options to be selected by a user of digital transmitting device 102-i. As can been seen in FIG. 3, a user has already input the User ID A93B on menu screen 302.

When the user selects option “1” on menu screen 302, digital transmitter 102 activates scanning mechanism 212 to scan in documents as discussed above. When the user selected option “3”, menu screen 304 is displayed to receive input from the user directly entering each character of a desired e-mail address using displayed virtual buttons. Menu screen 304 shows a practical example of a user selecting characters for a desired e-mail address. Menu screen 304 is presented by script code executing in CPU(s) 202 that allows the user to see alphabetic and symbolic characters by depressing virtual buttons 1004 to move forward and backward through a displayed hierarchical list of available alphabetic and symbolic characters. Script code executes in CPU(s) 202 to enable a user to select a displayed character by depressing virtual button 1006. Menu screen 304 shows that the user has entered the e-mail address “SHENRY@URL.COM”. Then, when virtual button 1006 is depressed on menu screen 304, the user sees a transition to menu screen 306.

Menu screen 306 displays a prompt for the user to manually enter a signature. The manual entry will preferably be done with a pen or stylus upon touch sensitive menu screen 210. The pen or stylus can also be used to make the input to menu screens 302 and 304. As can be seen in menu screen 306, the result of the manually entered signature is displayed. Alternatively, if digital transmitter device 102-i and/or server 106 performed a validation routine the result of which was negative as to the validity of the input from the user of the User ID and/or the manually entered signature, menu screen 306 could display a diagnostic showing a denial of access. After menu 306, a transition is made back to a previous menu screen (not shown) were the user can enter another User ID in a manner similar to the input shown in FIG. 304 with respect to menu screen 304.

In transmitting an e-mail message after the foregoing input sequence from a user, digital transmitter device 102-i uses an image composer to compose and integrate the manually entered signature and/or User ID with the scanned document(s) and then assembles message data to be sent in an e-mail message through interconnecting network 104 to the e-mail address(es) that was selected or otherwise entered by the user, as discussed above. Other virtual buttons on the touch sensitive menu screen 210 are also contemplated in order to provide for the initiation of other or additional functions by the user, such as a menu virtual item button 1002 seen in FIGS. 3-5.

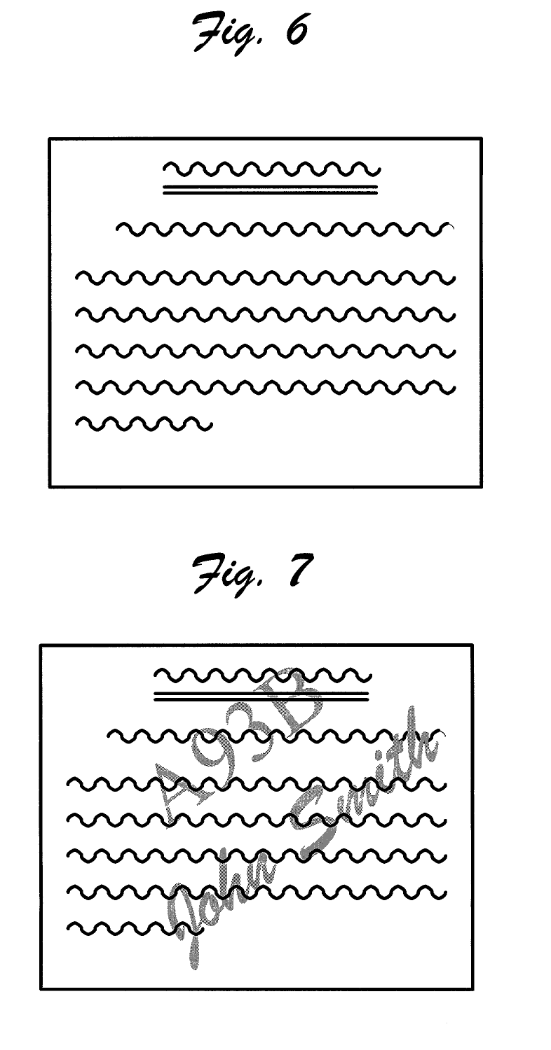

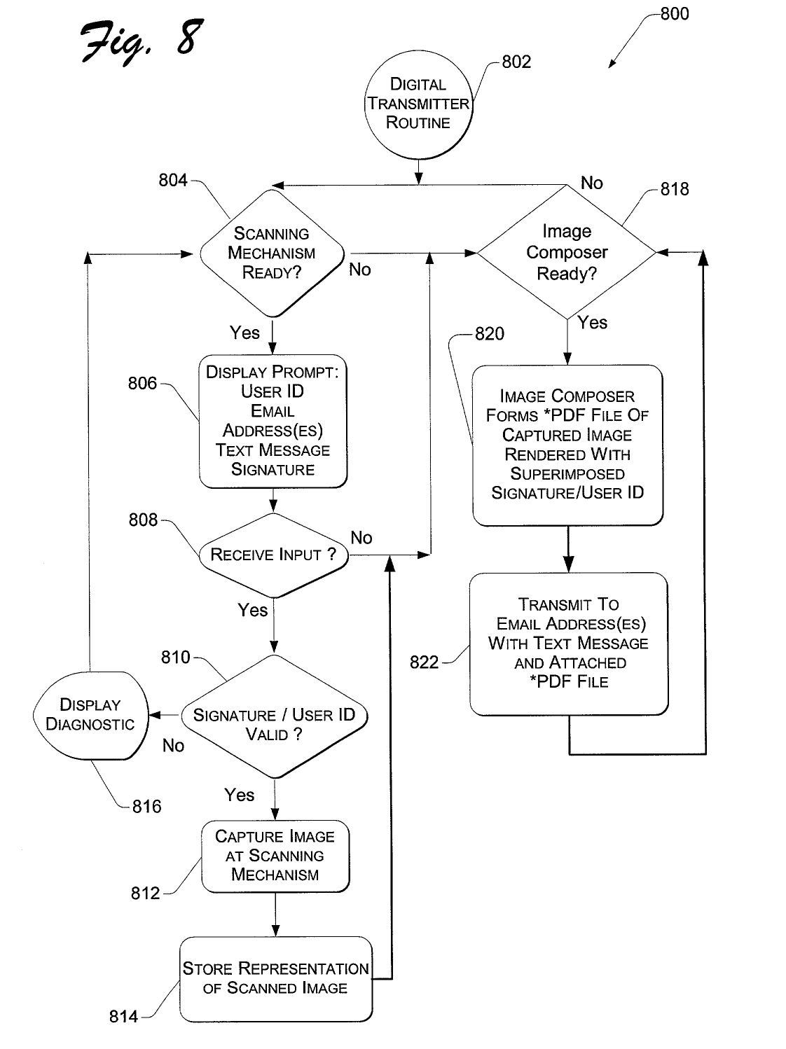

Before a user places one or more pieces of paper in a sheet feeder to be optically scanned with a scanning mechanism into a digital transmitter device, one such piece of paper can have an appearance such as is seen in FIG. 6. After the document composition is performed by the digital transmitter device, the one or more of each rendered page has a representation of the manually entered signature and/or the User ID superimposed thereon as is seen in FIG. 7. Whether one or all of the rendered pages are to bear the superimposed entries is an option left to the user or to an administrator of the digital transmitter device, as are the placement and appearance of the superimpositions upon the rendered page. By way of example, if the document composition process produces a PDF file from scanned documents, a user that opens the PDF file with a PDF reader will see the superimposed rendering on the pages of document in the PDF file. It is preferable, in order to ensure security as to the source of documents received by an e-mail message, that the PDF document will not be separable from the superimpositions. Other data can be superimposed by the document composition component of the digital transmitter device, such as the time, date, sending e-mail address, etc. Of course, data formats other the PDF, as discussed above, can be used by the image composer.

Exemplary Embodiment of Digital Transmitter Device Capture for Handwriting Collection and Distribution

FIG. 8 shows a flow diagram, according to an embodiment of the present invention, depicting a method for using a digital transmitter device. With this in mind, CPU(s) 202 can be configured to perform the operations described below. By way of further example, a flow diagram is depicted in FIG. 8 to illustrate certain exemplary functions that can be performed using CPU(s) 202 and the other resources in digital transmitter device 102-i. Here, a process 800 is provided.

FIG. 8 shows process 800 beginning at step 802 which directs a process flow to step 804. At step 804, a query is made as to whether the scanning mechanism of the digital transmitter device is ready. If so, the process 800 moves control to step 806 where digital transmitter device 102-i displays a prompt upon touch sensitive menu screen 210. In order to display the prompt, it is preferable that the server module 214 of memory 206 in digital transmitter device 102-i serves a menu page that is stored in memory 206 to CPU 202 for execution of script code. The script code being executed by CPU 202 effects a function to be performed by digital transmitter device 102, such as receiving input from a user that is entered upon touch sensitive menu screen 210, or the initiation of a function by the user depressing a function related virtual button that is displayed upon touch sensitive menu screen 210. The script code will preferably be executed in conjunction with an interpretation of the menu page. Note that in certain implementations, the menu page can be directly interpreted by script code executing on CPU 202 without any prior storage in menu documents in memory 206 or use of server module 214 in digital transmitter device 102-i.

If, at step 804 it is determined that the scanning mechanism is not ready, then the process flows to step 818. If the scanning mechanism is ready to scan a first or a subsequent set of documents, then the process control moves to step 806 where the user is prompted to enter various input upon a user interface to the digital transmitter device. By way of example, such a user interface could be touch sensitive menu screen 210 of digital transmitter device 102 as seen in FIG. 2. The user enters, at step 808, a User ID, one or more e-mail addresses, a manually entered signature using a pen or a stylus, and an optional text message to be sent with the e-mail message. It is determined at step 808 whether or not the user has made input to the user interface. If the user has not made input to the user interface then the process 800 passes control to step 818. If, however, user has made input using the user interface at step 806, then the process moves to step 810.

At step 810, an access control check is preformed upon the User ID and/or the manually entered signature. By way of example, the User ID/Signature File & Code component 224 of either digital transmitter device 102 or server 106 is queried to determine whether or not the input User ID matches the manually entered signature. This matching routine can be performed using known handwriting recognition techniques, such as those incorporating a comparison of the speed at which a signature is executed. If the access control check results in a denial of access, then a diagnostic is displayed to the user on the user interface at step 816 and the process 800 returns control to step 804. If access is permitted, then process 800 proceeds to step 812 where the scanning mechanism scans in the documents at the scanning mechanism for storage at the digital transmitter device.

Process 800 then passes control to step 814 where a representation of the scanned images are stored. After step 814, process 800 passes control to step 818 where it is determined whether or not the image composer component 217 and CPU(s) 202 of the digital transmitter device 102 are ready to compose the set of scanned in documents for subsequent e-mail message transmission. Image composer component 217 of digital transmitter device 102 can be used, in conjunction with scanning mechanism 212, to maintain data and/or algorithms, software, firmware, or other process control means for composing documents from the manually input signature of the user and the optically scanned documents.

After the determination at step 814 that the digital transmitter device 102 is prepared to compose the scanned set of documents, process 800 then proceeds to step 820. At step 820, image composer component 217 of the digital transmitter device 102 composes the documents using the manually input signature and/or the User ID integrated into a digital rendering of the set of scanned documents. At step 822, an e-mail message is assembled and transmitted to the e-mail address(es) input or otherwise specified by the user at step 806. Attached to the e-mail message is a file containing the composed document containing the digitized images of the set of scanned documents with a superimposed representation of the user's manually entered signature and/or User ID. After the transmission of the e-mail message at step 822, the process returns to step 818 where another query is made as to whether or not the digital transmitter device 102 is ready to compose another set of scanned document. This query is preferable in that the composition of documents can be time consuming for digital transmitter device 102, depending for instance upon the number of pages that were scanned. If the digital transmitter device 102 is determined not to be ready for further image composition at step 818, then the process 800 passes control to step 804 for a query as to whether the scanning mechanism is ready to scan another set of documents. Process 800 repeats the foregoing procedure. The procedural repetition enables documents to be scanned when the scanning mechanism of the digital transmitter device is ready.

It is contemplated that process 800, and other portions of the disclosure herein, can be modified to enhance assurances as to the authenticity of a signature that is born on a document that is transmitted by a digital transmitter device. Several examples of authentication techniques follow. One such technique is to capture each transmitted signature for storage in a database. The database provides an audit trail for later research by network security personnel, if desired. Additionally, an originally stored reference signature, such as that corresponding to a particular User ID, can be stored in a database for comparison to the transmitted signature in yet another form of audit trail that can be used for later research by network security personnel, if desired. The transmitted signature can be automatically compared to the reference signature, or other characteristics thereof (e.g. the speed at which all or a portion of the signature was signed), to arrive at a statistical assessment of the differences and similarities there between. One or more predetermined thresholds of these differences and similarities can be set above which an alert can be transmitted to network security personnel for further evaluation as to authenticity. These predetermined thresholds serve as a degree of match validation that can be quantified when transmitted or otherwise made available to network security personnel. With respect to signed documents that relate to financial transactions and/or confidential or sensitive communications, relatively low thresholds might be set, as compared to common documents, to ensure a substantial degree of match validation. Signature validation techniques can be implemented such that the predetermined thresholds can be set, adjusted, or removed, as desired upon demand of network security personnel. Other factors could be preconfigured in signature validation techniques to contribute to a calculus for arriving at values for the respective predetermined thresholds, such as the electronic address to which a signed document is to be transmitted (e.g. inside vs. outside of a local intranet) by the digital transmitter device.

The foregoing Detailed Description has set forth an example of transmitting an e-mail message from a digital transmitter device. Embodiments of the present invention contemplate other types of data that can also be addressed and transmitted from a digital sender device to an electronic address, including those now known and those yet to be developed. As such, and in addition to an e-mail transmission, embodiments of the present invention include a transmission from a digital sender device to an electronic address that includes an address of a network resource on a network and a destination location thereat. By of example, and not by way of limitation, the electronic address can be a file folder address at a server on a network and can also be a Web site address at a server on a network.

Thus, although some preferred embodiments of the various methods, systems, and programs of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the spirit of the invention as set forth and defined by the following claims.

What is claimed is:

1. A computer-readable medium having computer-executable instructions which, when executed on a processor, direct a computer to perform a method comprising:
composing a digital image at a digital transmitter device from:
an optically scanned image received at the digital transmitter device; and
a handwriting image received at a touch sensitive input device of the digital transmitter device;
performing a validation routine of the handwriting image against an access control database prior to transmitting a network message including the digital image from the digital transmitter device to an electronic address including an address of a network resource and a destination location thereat.

2. The computer-readable medium as defined in claim 1, where the digital image is rendered so as to superimpose the handwriting image over the optically scanned image.

3. The computer-readable medium as defined in claim 2, where the digital image is rendered such that the superimposed handwriting image does not substantially obscure any portion of the optically scanned image.

4. The computer-readable medium as defined in claim 1, wherein:
the digital transmitter device is a digital camera; and
the optically scanned image is received at a scanning mechanism is a digital photograph.

5. The computer-readable medium as defined in claim 1, further comprising inputting the electronic address to the digital transmitter device.

6. The computer-readable medium as defined in claim 5, wherein the inputting the electronic address to the digital transmitter device comprises inputting the electronic address using the touch sensitive input device.

7. The computer-readable medium as defined in claim 1, wherein the validation routine is selected from the group consisting of:
a handwriting speed routine including:
capturing the speed of execution of the handwriting image received at the touch sensitive input device; and
evaluating the captured speed of execution against routine against the access control database;
a bit map routine including:
composing the handwriting image received at the touch sensitive input device into a bit map;
evaluating the bit map against the access control database to determine a statistical value to which the bit map matches a reference in the access control database; and
comparing the statistical value to a predetermined threshold;
an identification code routine including:
capturing a user ID input and received at the touch sensitive input device; and
evaluating the captured User ID against the access control database;
a handwriting storage routine including:
composing the handwriting image received at the touch sensitive input device into a bit map; and
storing the bit map in a database.

8. The computer-readable medium as defined in claim 1, wherein the digital transmitter device is selected from the group consisting of from the group consisting of a digital camera, a hand held scanner, a desk top scanner, a fax machine, a copier, a multifunction peripheral (MFP), and a digital network copier.

9. The computer-readable medium as defined in claim 1, wherein the electronic address is selected from the group consisting of:
an electronic mail (e-mail) address at an email server on a network;
a file folder address at a server on a network; and
a Web site address at a server on a network.

10. The computer-readable medium as defined in claim 1, wherein the digital image has a format selected from the group consisting of an ASCII formatted data format, a word processor format, a spread sheet data format, a PDF data format, a slide show software data format, a GIFF data format, a TIFF data format, a JPEG data format, a bit-map data format, an OCR data format, and an encoded data format.

11. A computer-readable medium having computer-executable instructions which, when executed on a processor, direct a computer to perform a method comprising:
receiving an electronic address, including an address of a network resource and a destination location thereat, from a touch sensitive input device of a digital transmitter device;
composing a digital image at a digital transmitter device from:
an optically scanned image received at the digital transmitter device; and
an input image received at a touch sensitive input device of the digital transmitter device, wherein the digital image is rendered so as to superimpose the input image over the optically scanned image;
performing a validation routine of the input image against an access control database;
if the validation routine validates the input image, then transmitting a network message including the rendered digital image from the digital transmitter device to the electronic address.

12. The computer-readable medium as defined in claim 11, wherein the input image is selected from the group consisting of a textual image and a handwriting image.

13. The computer-readable medium as defined in claim 11, wherein the digital transmitter device is selected from the group consisting of from the group consisting of a digital camera, a hand held scanner, a desk top scanner, a fax machine, a copier, an MFP, and a digital network copier.

14. The computer-readable medium as defined in claim 11, wherein the electronic address is selected from the group consisting of:
an e-mail address at an e-mail server on a network;
a file folder address at a server on a network; and
a Web site address at a server on a network.

15. The computer-readable medium as defined in claim 11, wherein the digital image has a format selected from the group consisting of an ASCII formatted data format, a word processor format, a spread sheet data format, a PDF data format, a slide show software data format, a GIFF data format, a TIFF data format, a JPEG data format, a bit-map data format, an OCR data format, and an encoded data format.

16. A computer-readable medium having computer-executable instructions which, when executed on a processor, direct a computer to perform a method:
digitizing an optically received image in a digital camera;
inputting upon a touch sensitive input device of the digital camera:
an electronic address including an address of a network resource and a destination location thereat; and
an input image;
composing a digital document at a digital camera from:
the digitized optically received image; and
the input image;
wherein the digital document is rendered so as to superimpose the input image over the digitized optically received image;
transmitting a network message including the digital document from the digital camera to the electronic address.

17. The computer-readable medium as defined in claim 16, wherein the input image is selected from the group consisting of a textual image and a handwriting image.

18. The computer-readable medium as defined in claim 17, wherein the transmitting a network message further comprises a validation routine against an access control database prior to transmitting the network message.

19. The computer-readable medium as defined in claim 18, wherein the validation routine is selected from the group consisting of:
a handwriting speed routine including:
capturing the speed of execution of the handwriting image received at the touch sensitive input device; and
evaluating the captured speed of execution against routine against the access control database;
a bit map routine including:
composing the handwriting image received at the touch sensitive input device into a bit map;
evaluating the bit map handwriting image against the access control database to determine a statistical value to which the bit map handwriting image matches a reference in the access control database; and
comparing the statistical value to a predetermined threshold;
an identification code routine including:
capturing a user ID input and received at the touch sensitive input device; and
evaluating the captured User ID against the access control database;
a handwriting storage routine including:
composing the handwriting image received at the touch sensitive input device into a bit map; and
storing the bit map in a database.

20. The computer-readable medium as defined in claim 16, wherein the electronic address is selected from the group consisting of:
an e-mail address at an e-mail server on a network;
a file folder address at a server on a network; and
a Web site address at a server on a network.

21. The computer-readable medium as defined in claim 16, wherein the digital image has a format selected from the group consisting of an ASCII formatted data format, a word processor format, a spread sheet data format, a PDF data format, a slide show software data format, a GIFF data format, a TIFF data format, a JPEG data format, a bit-map data format, an OCR data format, and an encoded data format.

22. A system comprising:
a network resource, in communication with an interconnected network, for serving an electronic address;
a digital transmitter device having:
a communication link with the interconnected network;
a touch sensitive input device;
means for storing an access control database;
means for validating a manually input image that is input upon the touch sensitive input device against the access control database;
an optical scanner to optically scan at least one object to form corresponding scanned object data;
means for activating said optical scanner;
means for storing the optically scanned object data;
means, when the means for validating validates the manually input image, for:
composing a digital image into transmitted message data, wherein the digital image is rendered so as to superimpose the manually input image over the optically scanned object data; and
transmitting transmitted message data over the interconnected network to the electronic address.

23. The system as defined in claim 22, further comprising means for outputting a diagnostic when the means for validating does not validates the manually input image.

24. The system as defined in claim 23, wherein the means for validating does not validate the manually input image when an evaluation of the digital image of the manually input image against a reference in the access control database determines a statistical value that exceeds a predetermined threshold.

25. The system as defined in claim 22, wherein the digital transmitter device is selected from the group consisting of from the group consisting of a digital camera, a hand held scanner, a desk top scanner, a fax machine, a copier, an MFP, and a digital network copier.

26. The system as defined in claim 22, wherein the composed digital image in the transmitted message data includes data having a format composed by the means for composing that is selected from the group consisting of an ASCII formatted data format, a word processor format, a spread sheet data format, a PDF data format, a slide show software data format, a GIFF data format, a TIFF data format, a JPEG data format, a bit-map data format, an OCR data format, and an encoded data format.

27. The system as defined in claim 22, wherein the network resource is a server and the electronic address at the network resource is a destination location at the address of the network resource and is selected from the group consisting of:
an e-mail address;
a file folder address; and
a Web site address.

28. In a digital transmitter device in communication through a network with a network resource having an address on the network, the digital transmitter device including a touch sensitive input device, an optical scanner to optically scan at least one object to form corresponding scanned object data, memory to store optically scanned data, a composer to digitize the stored optically scanned data into transmitted message data that is in a data format, and logic that is configurable to execute a program embodied on a computer-readable medium, the program comprising:
a code segment to activate the optical scanner to optically scan at least one object to form corresponding scanned object data;
a code segment to activate the composer to form a digital image in the transmitted message data from:
the scanned object data stored in the memory; and
a handwriting image received at the touch sensitive input device, wherein the digital image is rendered so as to superimpose the handwriting image over the scanned object data;
a code segment to activate a validation routine to validate the handwriting image against an access control database;
a code segment to activate a transmitter of the digital transmitter device to transmit the transmitted message data over the network to a destination location at the address of the network resource after the composer has composed the transmitted message data.

29. The program as defined in claim 28, further comprising a code segment to output a diagnostic when the validation routine is negative.

30. The program as defined in claim 28, wherein the validation routine is negative when an evaluation of the handwriting image against a reference in the access control database determines a statistical value that exceeds a predetermined threshold.

31. The program as defined in claim 28, wherein the data format is selected from the group consisting of an ASCII formatted data format, a word processor format, a spread sheet data format, a PDF data format, a slide show software data format, a GIFF data format, a TIFF data format, a JPEG data format, a bit-map data format, an OCR data format, and an encoded data format.

32. The program as defined in claim 28, wherein the digital transmitter device is selected from the group consisting of from the group consisting of a digital camera, a hand held scanner, a desk top scanner, a fax machine, a copier, an MFP, and a digital network copier.

33. The program as defined in claim 28, wherein the destination location at the address of the network resource is selected from the group consisting of:
an e-mail address at an e-mail server on the network;
a file folder address at a server on the network; and
a Web site address at a server on the network.

34. The program as defined in claim 28, wherein the code segment to activate a validation routing to validate the handwriting image against an access control database further comprises a code segment to:
compose the handwriting image received at the touch sensitive input device into a bit map; and
store the bit map in the access control database.

35. A computer-readable medium having computer-executable instructions which, when executed on a processor, direct a computer to perform a method comprising:
composing a digital image from an optically scanned image and a handwriting image;
performing a validation routine of the handwriting image against an access control database, and if the validation routine validates the handwriting image against the access control database, then transmitting a network message including the digital image to an electronic address including an address of a network resource and a destination location thereat.

36. The computer-readable medium as defined in claim 35, where the digital image is rendered so as to superimpose the handwriting image over the optically scanned image.

37. The computer-readable medium as defined in claim 36, where the digital image is rendered such that the superimposed handwriting image does not substantially obscure any portion of the optically scanned image.

38. The computer-readable medium as defined in claim 35, further comprising inputting the electronic address to the digital transmitter device using a touch sensitive input device.

39. The computer-readable medium as defined in claim 35, wherein the processor executing the computer-executable instructions is included in a digital transmitter device.

40. A computer-readable medium having computer-executable instructions which, when executed on a processor of a digital transmitter device, direct a computer to perform a method comprising the steps of:
receiving an electronic address of a network resource;
composing a digital image at the digital transmitter device from:
an optically scanned image; and
an input image, wherein the digital image is rendered so as to superimpose the input image over the optically scanned image;
validating the input image against an access control database; and
if the validating validates the input image, forming an e-mail message addressed to the electronic address, wherein the e-mail message includes the digital image.
